(19) United States
(12) Patent Application Publication
(10) Pub. No.: US 2012/0212416 A1
(43) Pub. Date: Aug. 23, 2012

(54) EXTERNAL DISPLAY SYSTEM FOR DISPLAYING DATA AND VISUALS OF AN INPUT OPERATING INTERFACE

(75) Inventor: Yuan-Jung CHANG, New Taipei City (TW)

(73) Assignee: DEXIN CORPORATION

(21) Appl. No.: 13/183,432

(22) Filed: Jul. 15, 2011

(30) Foreign Application Priority Data
Feb. 17, 2011 (TW) 100202903

(51) Int. Cl. G06F 3/033

(52) U.S. Cl. 345/163

(57) ABSTRACT

An external display system for displaying data and visuals of an input operating interface comprises: a computer module (1), a mouse module (2) and a display module (3). The mouse module (2) has a first wireless transceiver unit (24). When data of operation keys settings, default parameters, and parameter setting values or visuals related to the computer module (1) or the mouse module (2) is set, or when data of default operation keys and parameter setting values of the mouse module (2) or the keyboard (12) are in demand, the first wireless transceiver unit (24) transfers signals of the data to a second wireless transceiver unit (31) on the display module (3), the microprocessor (32) of the display module (3) processes the data and saved the data of the operation keys, the parameter setting values or the visuals in the storage unit (33) and displays the data or visuals on a display unit (34) of the display module (3).

### BACKGROUND OF THE INVENTION

1. Field of the Invention

The present invention relates to a display system, in particular, the present invention relates to an external display system for displaying data and visuals of an input operating interface.

2. Description of Prior Art

Nowadays, computers are critical work tools for modern people, job tasks are mostly accomplished by computation and control of computers.

In addition to the work places, computers are useful for entertaining purposes for example, playing computer games. Except for particular computer games using joysticks, most of computer games use an operation keyboard and a mouse for controlling game actions in playing computer games. In order to provide a quick reference of operation key settings and key locations to users during game playing, a sub display is offered in the main display of a computer game for displaying the operation key settings and the key locations. Such displaying method allows a user to get quick reference to the operation instructions without leaving the main frame or window of the computer game and go to the database of the game operation instructions. However, a sub display preoccupies the display space of the default display in a computer game and thus is inconvenient to a user when playing a game.

Under certain occasions, a mouse is set to perform special functions (such as performing functions of a set of hot keys replacing keyboard and mouse actions). In other occasions, a mouse is set to perform default and basic functions. The conversion in between is inconvenient to users.

In addition, users generally are allowed to access to parameter settings of the keyboard or the mouse via applications of the operating system of the computer, but users are not allowed to view or understand parameter setting usage status (such the data of the press count of certain key on the keyboard) of the keyboard and the mouse after using a keyboard and a mouse for a period of time with a computer. Without the information, a user does not have references in considering when to replace a keyboard and a mouse. Thus, it is also a disadvantage the present invention expects to resolve.

### SUMMARY OF THE INVENTION

The objective of the invention is to overcome the disadvantages when using a traditional keyboards or mouse. The present invention provides an external display system for displaying data of operation instructions parameter setting values or visuals (pictures and images) etc. of computer games, graphic software, sensors etc., or displaying default parameter setting of a mouse module as well as a current parameter setting usage status of a mouse module or a keyboard after using for a period of time.

Another objective of the present invention is to provide an external display system installed with computer game data (comprising specific function hot keys for controlling actions).

In order o achieve the above objective, the present invention provides an external display system for displaying input operating interface data, which comprises:

a computer module, which at least comprises a host, a keyboard electrically coupled with the host, a display electrically coupled with the host; and the host has at least a first and second USB connection ports;

a mouse module, which has a control unit, a USB transmission interface unit, a switch unit, a first wireless transceiver unit and a sensor unit; the control unit are electrically coupled with the USB transmission interface unit, switch unit and first wireless transceiver unit; and the mouse module is electrically coupled with the first USB connection port via USB transmission interface unit;

a display module, which has a second wireless transceiver unit, a microprocessor electrically coupled with the second wireless transceiver unit, a storage unit electrically coupled with the microprocessor, and a storage unit electrically coupled with the microprocessor;

wherein the signals are transferred to and received by the second wireless transceiver unit with the mouse module via the first wireless transceiver unit, the microprocessor retrieves internal data and visuals in the storage unit, or saves the data from the mouse module in the storage unit according to the received signals, the display unit displays saved or retrieved data; or the internal data in the storage unit retrieved by the microprocessor is transferred to and received by the first wireless transceiver unit, then the received internal data is transferred to and displayed at the computer module.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic block diagram of an external display system for displaying input operating interface data according to the present invention;

FIG. 2 is a schematic diagram illustrating usage status of a preferred embodiment according to the present invention;

FIG. 3 is a schematic diagram of another preferred embodiment according to the present invention; and

FIG. 4 is a schematic diagram of the other preferred embodiment according to the present invention.

### DETAILED DESCRIPTION OF THE INVENTION

In cooperation with attached drawings, the technical contents and detailed description of the present invention are described thereinafter according to preferred embodiments, being not used to limit its executing scope. Any equivalent variation and modification made according to appended claims is all covered by the claims claimed by the present invention.

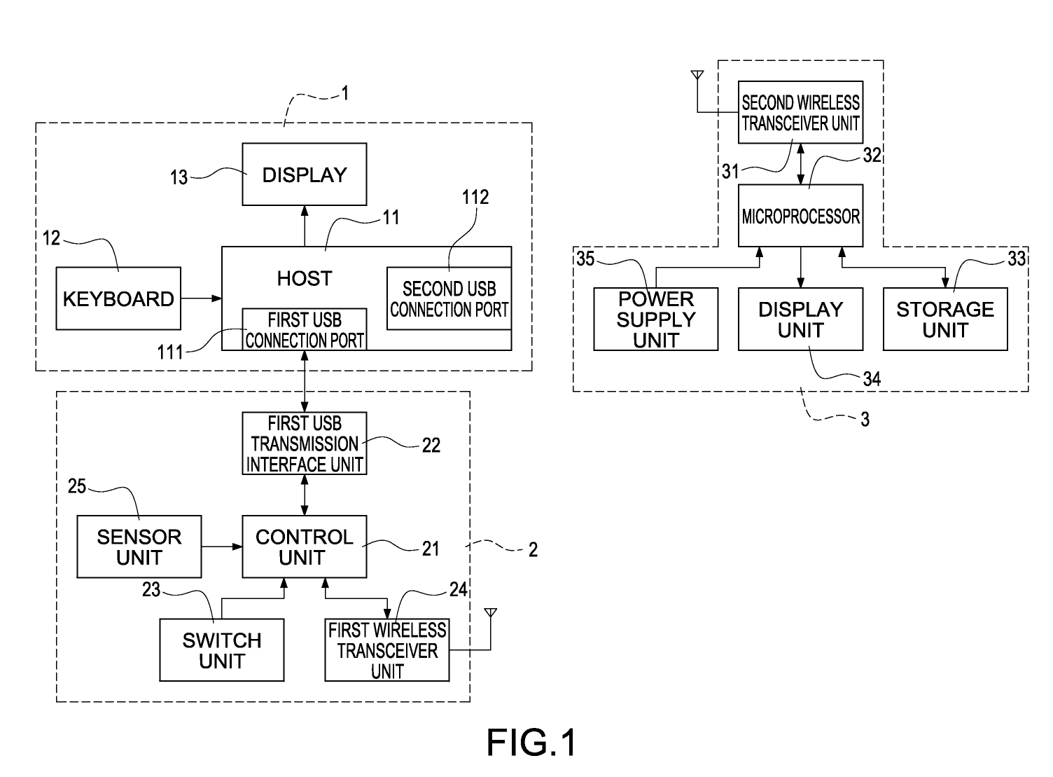

FIG. 1 is a schematic block diagram of an external display system for displaying input operating interface data according to the present invention. As shown in the diagram, an external display system for displaying input operation interface settings data of the present invention comprises: a computer module 1, a mouse module 2 and a display module 3.

The computer module 1 at least comprises a host (computer motherboard) 11, a keyboard 12 electrically coupled with the host 11, a display 13 electrically coupled with the host 11. The host 11 has at least a first USB connection port 111 and a second USB connection port 112. In FIG. 1, the computer 1 is a desktop computer or a notebook computer.

The mouse module 2 has a control unit 21, a first USB transmission interface unit 22, a switch unit 23, a first wireless transceiver unit 24 and a sensor unit 25. The control unit 21 is electrically coupled with the first USB transmission interface unit 22, the switch unit 23 and the first wireless transceiver unit 24 (a radio frequency wireless receiver/transmitter or a Infrared transceiver). The mouse module 2 is electrically coupled with the first USB transmission interface unit 22 and the first USB connection port 111. The received signals by the mouse module 2 or the instructions generated by operating the switch unit 23 are processed by the control unit 21 and transferred by the first USB transmission interface unit 22 to the host 11 for computation and displayed on the display 13. The first wireless transceiver unit 24 is used for transferring signals to the display module 3, or receiving signals transferred by the display module 3. In addition, usage status data in the mouse module 2 is transferred to an internal buffer or a memory in the control unit 21, for example, press counts or roll counts of a switch unit. Further, the sensor unit 25 is used for retrieving movement signals of a mouse for controlling the icon movement on the display. In FIG. 1, the switch unit 23 is composed of a left button, a right button and a wheel.

The display module 3 is electrically coupled via wireless transmission with the mouse module 2. The display module 3 includes: a second wireless transceiver unit 31 (a radio frequency wireless receiver/transmitter or a Infrared transceiver), a microprocessor 32, a storage unit 33, a display unit 34 and a power supply unit 35. The microprocessor 32 is electrically coupled with the second wireless transceiver unit 31, storage unit 33 and display unit 34 for receiving signals transferred from the first wireless transceiver unit 24. The signals are processed by the microprocessor 32 and saved in the storage unit 33 or the message of the signals are displayed on the display unit 34. Further, the storage unit 33 is preloaded in factory with settings (operation instructions) of operation keys, parameter setting values or data, the operation keys or the parameter setting values or visuals etc. of simple computer games, or default parameter setting values of the mouse module 2, and parameter setting usage status of the mouse module 2 or the keyboard 12 after using for a period of time. Further, the power supply unit 35 is used for providing working power of each unit. The power supply unit 35 can be a battery or a USB plug to plug in the second USB connection port 112 of the computer module 1 in the host 11, whereby the host 11 provides the working power. In FIG. 1, the storage unit 33 is a Electrically-Erasable Programmable Read-Only Memory (EEPROM) or a Flash Memory. The display unit 34 is a LCD (Liquid Chrystal Display).

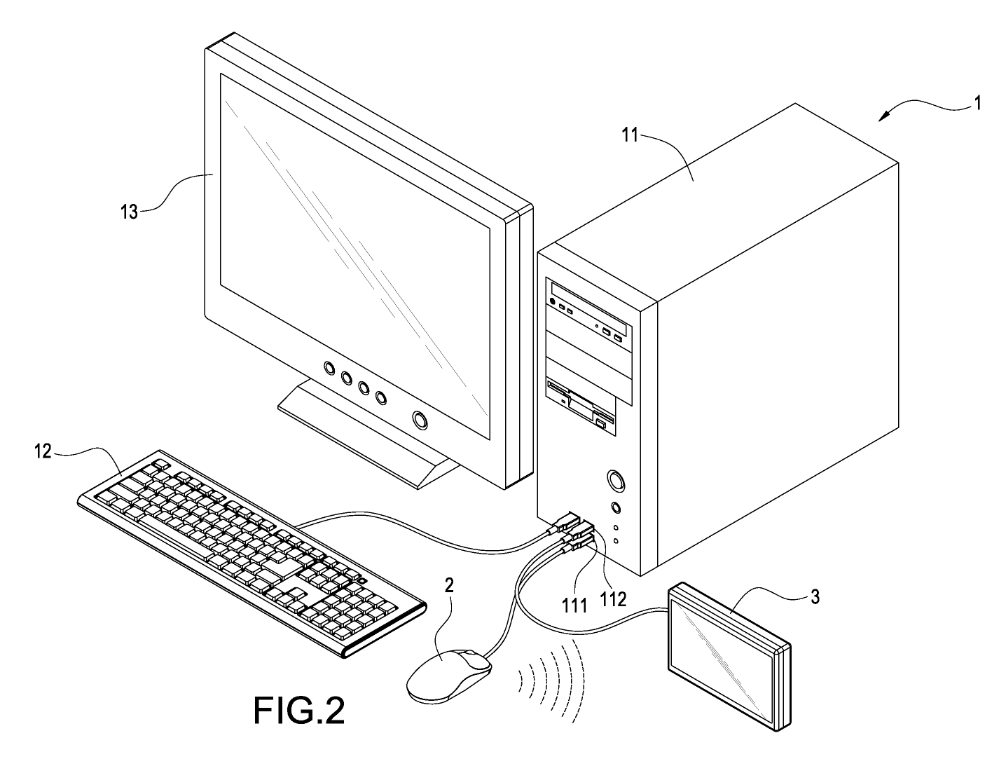

Referring to FIG. 1 and FIG. 2, FIG. 1 is a schematic block diagram of an external display system for displaying input operating interface data according to the present invention and FIG. 2 is a schematic diagram illustrating usage status of a preferred embodiment according to the present invention. As shown in the diagram, the computer module 1, the mouse module 2 and the display module 3 are electrically coupled to perform operations. In addition to the existed operation input of the keyboard 12 and the mouse module 2 on the computer module 1, when a user executing computer games in the computer module 1 and forget data, such as operation keys settings (key locations) or default parameter setting value, of the keyboard 12 and mouse module 2, a user presses switch unit 23 on the mouse module 2 to send signals to the control unit 21, the control unit 21 triggers the first wireless transceiver unit 24 to transfer the signals to the display module 3. The second wireless transceiver unit 31 receives the signal and transfers the signals to the microprocessor 32 for retrieving operation keys data of the computer games saved in the storage unit 33 and displaying the data on the display unit 34. Or the operation keys data of the computer games are retrieved by the microprocessor 32 and transferred to the mouse module 2 via the second wireless transceiver unit 31. The operation keys data is received by the first wireless transceiver unit 24 and transferred to the computer module 1 in the host 11 for computation via the control unit 21 and first USB transmission interface unit 22. Then the display 13 displays operation keys of the computer games to give quick required data to the user.

Further, if a user wants to access to current usage status data of the mouse module 2, the user can press left or right button of the switch unit 23 to retrieves the usage status data temporarily saved in the internal buffer or the memory of the control unit 21. The usage status data is transferred to the display module 3 via the first wireless transceiver unit 24. After usage status data is received by the second wireless transceiver unit 31 and processed by the microprocessor 32, the usage status data is saved in the storage unit 33, or displayed on the display unit 34.

Further, a user is allowed to set operation keys settings of computer games with the keyboard 12 and the mouse module 2 in the computer module 1, the set data of settings is transferred to the mouse module 2 via first USB transmission interface unit 22. Controlled by the control unit 21, the signals are transferred to the display module 3 via the first wireless transceiver unit 24. The signals are received by the second wireless transceiver unit 31, processed by the microprocessor 32 and saved in the storage unit 33, or displayed on the display unit 34. When the user wants to know the data such as operation keys data set in the last computer games, the user presses the switch unit 23 on the mouse module 2, the first wireless transceiver unit 24 transfers the signals via the control unit 21 to the display module 3. After the signals are received by the second wireless transceiver unit 31 and processed by the microprocessor 32, the operation keys data preset by the user and saved in the storage unit 33 is retrieved and displayed on the display unit 34. Or the operation keys data saved in the storage unit 33 is retrieved by the microprocessor 32, transferred back to the mouse module 2 via the second wireless transceiver unit 31. The operation keys data is received by the first wireless transceiver unit 24 and processed by the control unit 21, then transferred by first USB transmission interface unit 22 to the computer module 1. Then the operation keys data of the computer games is displayed on the display 13.

Or, a user presses the left button (as hot keys) of the mouse module 2, the external display module 3 displays action control buttons such as CTRL-C, CTRL-V and CTRL-D for performing action control, a user select an action control item (such as CTRL-C), the action control signals is transferred to the computer for performing the selected action control.

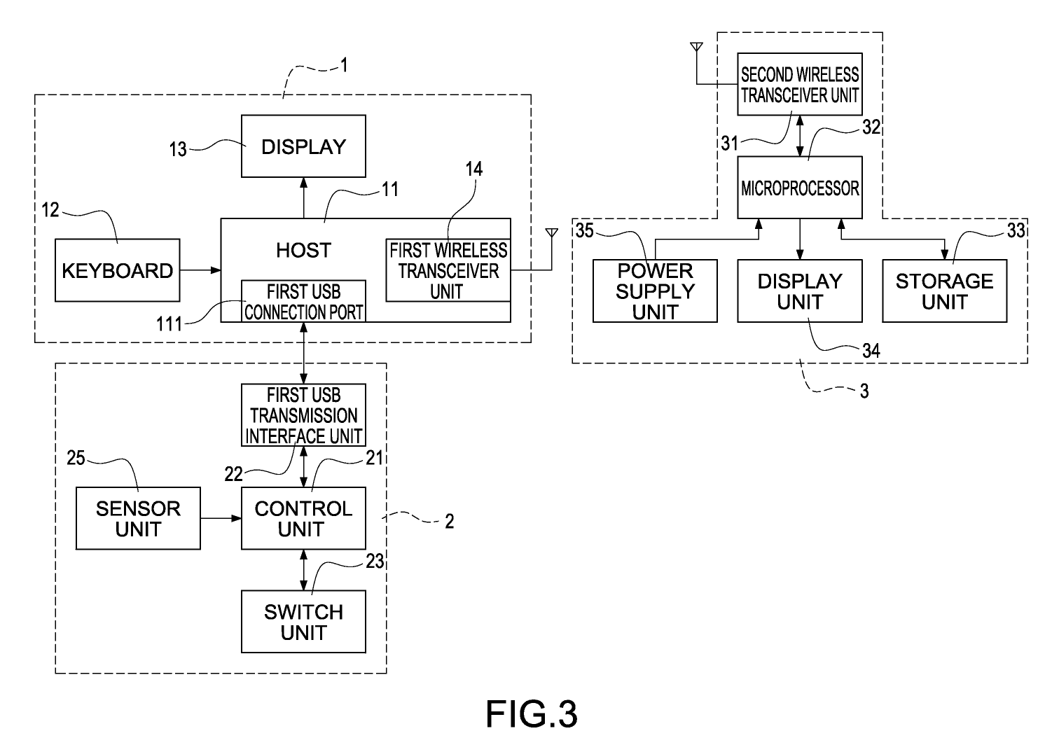

FIG. 3 is a schematic diagram of another preferred embodiment according to the present invention. As shown in the diagram, the embodiment is largely identical with the embodiment shown in the FIG. 2. The differences are that the first wireless transceiver unit 14 is installed in the host 11 of the computer module 1. When a user wants to access to data such as operation keys of computer games or operation setting values of the mouse module 2, the first wireless transceiver unit 14 transfers signals to the display module 3 after operating with the keyboard 12 or the mouse module 2. After the microprocessor 32 retrieves the internal data in the storage unit 33, the data such as operation keys, visuals of computer games or the related setting values of the mouse module is displayed on the display unit 34. Or, the microprocessor 32 retrieves the data in the storage unit 33 such as operation keys, visuals or related setting data of the mouse module and transfers the data directly to the host 11. The data is received by the first wireless transceiver unit 14 and is displayed on the display 13.

A user is allowed to operate with the keyboard 12 and the mouse module 2 to transfer the usage status data temporarily saved in an internal buffer or a memory of the control unit 21 to the display module 3 via first wireless transceiver unit 24. The usage status data is processed by the display module 3. Various usage status data recorded after the mouse module 2 is used for a period of time (data such as the key press count, the wheel roll count, usage time length of the mouse module) is displayed on the display unit 34.

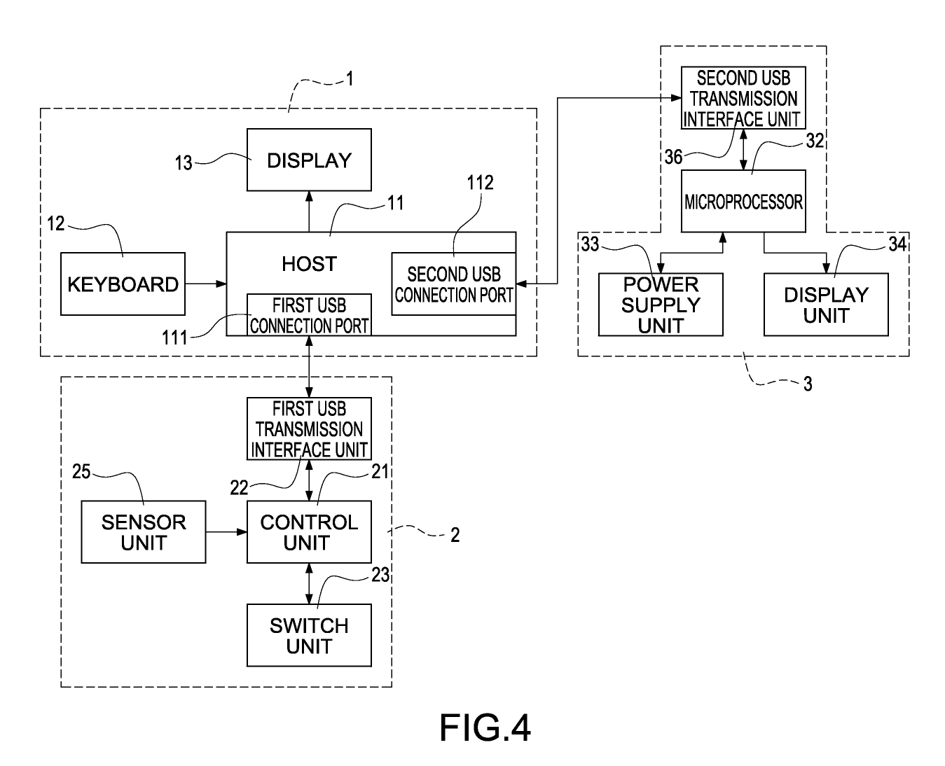

FIG. 4 is a schematic diagram of the other preferred embodiment according to the present invention. As shown in the diagram, the display module 3 is installed with a second USB transmission interface unit 36 according to the embodiment to allow the display module 3 to plug in second USB connection port 112 of the host 11 with second USB transmission interface unit 36.

When a user wants to access to data such as operation keys or visuals of computer games, or operation setting values of the mouse module 2, the host 11 transfers signals via the second USB connection port 112 to the display module 3. After operating with the keyboard 12 or the mouse module 2, the microprocessor 32 retrieves internal data in the storage unit 33 and displays the operation keys or the visuals of the computer games, or the operation setting values of the mouse module 2 on the display unit 34. Or, the microprocessor 32 retrieves the data in storage unit 33 such as the operation keys or the related setting values data of the mouse module 2. The second

USB transmission interface unit 36 transfers the data back to the host 11 to process. The data transferred back is displayed on the display 13.

Via operations of the keyboard 12 and the mouse module 2, a user is allowed to transfer usage status data temporarily saved in the internal buffer or the memory of the control unit 21 to the display module 3 via the second USB connection port 112. The usage status data including various usage status data (such as data of the key press count, the wheel roll count, the usage time length of the mouse module etc.) of the mouse module 2 is processed by the display module 3, and displayed on the display unit 34.

As the skilled person will appreciate, various changes and modifications can be made to the described embodiments. It is intended to include all such variations, modifications and equivalents which fall within the scope of the invention, as defined in the accompanying claims.

What is claimed is:

1. An external display system for displaying data and visuals of an input operating interface, the external display system electrically coupled with a display (13), a keyboard (12) and a computer module (1) of a host (11), the external display system comprising:
a mouse module (2) electrically coupled to the host (11) and having a first wireless transceiver unit (24);
a display module (3) having a second wireless transceiver unit (31), a microprocessor (32) electrically coupled with the second wireless transceiver unit (31), a storage unit (33) electrically coupled with the microprocessor (32), and a display unit (34) electrically coupled with the microprocessor (32);
wherein signals are transferred to and received by the second wireless transceiver unit (31) with the mouse module (2) via the first wireless transceiver unit (24), the microprocessor (32) retrieves internal data and visuals in the storage unit (33), or saves the data from the mouse module (2) in the storage unit (33) according to the received signals, the display unit (34) displays saved or retrieved data; or the internal data in the storage unit (33) retrieved by the microprocessor (32) is transferred to and received by the first wireless transceiver unit (24), then the received internal data is transferred to and displayed at the computer module (1).

2. The external display system of claim 1, wherein the data is operation keys settings of computer games, usage status of the mouse module (2), default parameters of the mouse module (2), operation keys settings of graphic software, parameter setting values of sensors, or visuals of sensors.

3. The external display system of claim 2, wherein computer module (1) is a desktop computer or a notebook computer.

4. The external display system of claim 3, wherein the host (11) has at least a first USB connection port (111).

5. The external display system of claim 4, wherein the mouse module (2) further comprises a control unit (21) electrically coupled with the first wireless transceiver unit (24), a first USB transmission interface unit (22) electrically coupled with the control unit (21) and first USB connection port (111), a switch unit (23) electrically coupled with the control unit (21).

6. The external display system of claim 5, wherein the switch unit (23) at least comprises a left button, a right button and a wheel.

7. The external display system of claim 6, wherein the first wireless transceiver unit (24) and second wireless transceiver unit (31) are radio frequency wireless receivers/transmitters or Infrared transceivers.

8. The external display system of claim 7, wherein the storage unit (33) is an Electrically-Erasable Programmable Read-Only Memory (EEPROM) or a Flash Memory.

9. The external display system of claim 8, wherein the display unit (34) is a LCD (Liquid Chrystal Display).

10. The external display system of claim 9, wherein the display module (3) further has a power supply unit (35), and the power supply unit (35) is a battery or a USB plug.

11. The external display system of claim 10, wherein the mouse module (2) further has a sensor unit (25) electrically coupled with control unit (21).

12. An external display system for displaying data and visuals of an input operating interface, the external display system and a mouse module (2) electrically coupled with a display (13), a keyboard (12) and a computer module (1) of a host (11), the external display system comprising:
a first wireless transceiver unit (14) electrically coupled with the host (11);
a display module (3) having a second wireless transceiver unit (31), a microprocessor (32) electrically coupled with the second wireless transceiver unit (31), a storage unit (33) electrically coupled with the microprocessor (32), and a display unit (34) electrically coupled with the microprocessor (32);
wherein upon operating on the keyboard or mouse module (2), the first wireless transceiver unit (14) transfers signals to the second wireless transceiver unit (31), the signals are received by the second wireless transceiver unit (31), the microprocessor (32) retrieves internal data of the storage unit (33) or saves the data transferred from the host (11) in the storage unit (33) according to the received signals, the display unit (34) displays the retrieved or the saved data; or transceiver unit (14), the received data is processed by the host (11) and displayed on the display (13) of the computer module (1).

13. The external display system of claim 12, wherein the data is operation keys settings of computer games, usage status of the mouse module (2), default parameters of the mouse module (2), operation keys settings of graphic software, parameter setting values of sensors, or visuals of sensors.

14. The external display system of claim 13, wherein computer module (1) is a desktop computer or a notebook computer.

15. The external display system of claim 14, wherein the host (11) has at least a first USB connection port (111).

16. The external display system of claim 15, wherein the mouse module (2) further comprises a first USB transmission interface unit (22) electrically coupled with the first USB connection port (111), a control unit (21) electrically coupled with the first USB transmission interface unit (22), a switch unit (23) electrically coupled with the control unit (21) and a sensor unit (25) electrically coupled with the control unit (21).

17. The external display system of claim 16, wherein the switch unit (23) at least comprises a left button, a right button and a wheel.

18. The external display system of claim 17, wherein the first wireless transceiver unit (14) and second wireless transceiver unit (31) are radio frequency wireless receivers/transmitters or an Infrared transceivers.

19. The external display system of claim 18, wherein the storage unit (33) is an Electrically-Erasable Programmable Read-Only Memory (EEPROM) or a Flash Memory.

20. The external display system of claim 19, wherein the display unit (34) is a LCD.

21. The external display system of claim 20, wherein the display module (3) further has a power supply unit (35), and the power supply unit (35) s a battery or a USB plug.

22. An external display system for displaying data and visuals of an input operating interface, a mouse module (2) and a display module (3) electrically coupled with a display (13), a keyboard (12) and a computer module (1) of a host (11), the external display module (3) comprising:
a second USB transmission interface unit (36) electrically coupled with the host (11) electrically coupled;
a microprocessor (32) electrically coupled with the second USB transmission interface unit (36);
a storage unit (33) electrically coupled with the microprocessor (32);
a display unit (34) electrically coupled with the microprocessor (32);
wherein the second USB transmission interface unit (36) receives signals transferred from the host (11), the received are processed by the microprocessor (32), then the microprocessor (32) retrieves the internal data in the storage unit (33) or saves the transferred data from the host (11) in the storage unit (33) according to the signals, the display unit (34) displays the retrieved or the saved data; or the retrieved data by the microprocessor (32) is transferred to and processed by the host (11), and displayed at the display (13) of the computer module (1).

23. The external display system of claim 22, wherein the data is operation keys settings of computer games, usage status of the mouse module (2), default parameters of the mouse module (2), operation keys settings of graphic software, parameter setting values of sensors, or visuals of sensors.

24. The external display system of claim 23, wherein computer module (1) is a desktop computer or a notebook computer.

25. The external display system of claim 24, wherein the host (11) at least a first USB connection port (111) and a second USB connection port (112), and the second USB connection port (112) is electrically coupled with the second USB transmission interface unit (36).

26. The external display system of claim 25, wherein the mouse module (2) further comprises a first USB transmission interface unit (22) electrically coupled with the first USB connection port (111), a control unit (21) electrically coupled with the first USB transmission interface unit (22), a switch unit (23) electrically coupled with the control unit (21).

27. The external display system of claim 26, wherein the switch unit (23) at least comprises a left button, a right button and a wheel.

28. The external display system of claim 27, wherein the storage unit (33) is an Electrically-Erasable Programmable Read-Only Memory (EEPROM) or a Flash Memory.

29. The external display system of claim 28, wherein the display unit (34) is a LCD.
